(19) United States
(12) Patent Application Publication
(10) Pub. No.: US 2020/0085536 A1
(43) Pub. Date: Mar. 19, 2020

(54) Device and Method for Accelerating Orthodontic Treatment Using Mechanical Vibrations

(71) Applicant: The Research Foundation for The State University of New York, Amherst, NY (US)

(72) Inventors: Mohammad Amin Karami, Buffalo, NY (US); Muath A. Bani-Hani, Hamburg, NY (US); Sawsan Tabbaa, Jacksonville, FL (US)

(21) Appl. No.: 16/495,475

(22) PCT Filed: Mar. 22, 2018
(86) PCT No.: PCT/US2018/023899

§ 371 Date: Sep. 19, 2019

Related U.S. Application Data
(60) Provisional application No. 62/475,018, filed on Mar. 22, 2017.

(51) Int. Cl. A61C 7/00; B06B 1/02; B06B 1/06; H01L 41/04; H01L 41/193; H01L 41/053

(52) U.S. Cl. CPC A61C 7/008; A61C 7/002; B06B 1/0276; B06B 2201/76; H01L 41/042; H01L 41/193; H01L 41/0533; B06B 1/0688

(57) ABSTRACT

A device for orthodontic treatment is disclosed. The device includes a first actuator configured to be attached to an orthodontic appliance and located proximate to a dentition. A second actuator is configured to be attached to the orthodontic appliance and located proximate to the dentition. A signal generator is in electrical communication with the first actuator and the second actuator. The signal generator is configured to provide a first drive signal to the first actuator and a second drive signal to the second actuator. In this way each actuator causes vibrational forces to be induced in the dentition. The actuators are configured such that the induced vibrational forces interfere with one another to cause an increased amplitude at a predetermined location in the dentition.

### CROSS-REFERENCE TO RELATED APPLICATIONS

This application claims priority to U.S. Provisional Application No. 62/475,018, filed on Mar. 22, 2017, now pending, the disclosure of which is incorporated herein by reference.

### FIELD OF THE DISCLOSURE

This disclosure relates to the field of orthodontics.

### BACKGROUND OF THE DISCLOSURE

Orthodontics is the dental field that treats malocclusion through the movement of teeth. This specialty deals primarily with the diagnosis, prevention and correction of malposition of the teeth and the jaws. Malocclusion implies that the upper and lower teeth don't align correctly in biting or chewing. Malocclusion includes irregular bite, cross bite, or overbite. Malocclusion may be seen as crooked, crowded, or protruding teeth. It may affect a person's appearance, speech, and/or ability to eat.

Malocclusion is usually corrected by using a continuous mechanical force to induce bone remodeling, thereby allowing the teeth to move to an optimal position. In this approach, orthodontic appliances provide a continuous static force to the teeth via, for example, an arch wire connected to brackets affixed to each tooth or via a removable appliance such as an aligner that fits over the dentition. As the teeth slowly move due to the force, the force is dissipated. The arch wires or aligner are adjusted progressively to add additional force and to continue the desired tooth movement.

Historically, it has been claimed that the ideal force to move a tooth would be a force which just overcome capillary blood pressure (20-26 grams per square centimeter). Excessive force would lead to capillary collapse, cutting off blood circulation and leading to areas of tissue necrosis and thus root resorption. The current approach, known as fixed orthodontic treatment, requires an extended period of about 2-3 years. Fixed orthodontic treatment also poses high risks of caries, external root resorption, and decreased patient compliance over time. Multiple studies have found a [symbol] correlation between extended treatment duration and the amount of root resorption experienced by a patient. However, even when no radiographic sign of root resorption is visible, it is accepted that most teeth undergoing orthodontic tooth movement will experience some degree of root resorption followed by repair. Radiographic evidence of root resorption after orthodontic treatment has been shown, and it was found that 21% of five hundred patients had evidence of root resorption. For this reason, accelerating orthodontic tooth movement (thus shortening treatment duration) is of necessary importance. Several novel modalities have been reported to accelerate orthodontic tooth movement, including low-level laser therapy, pulsed electromagnetic fields, electrical currents, corticotomy, distraction osteogenesis, and mechanical vibration.

It has been reported that low magnitude mechanical signals induced at a high frequency can stimulate bone formation. Vibration therapy has also been used to improve or maintain bone and muscle mass in rehabilitation of mobility impaired patients. Vibration therapy has been also utilized to combat decreased bone density and improving post-surgical healing. In a long-term animal study, daily 20-minute sessions of high-frequency (30 Hz) and low-magnitude 0.3 g force were shown to stimulate a 43% increase in bone density in the proximal femur.

Dental researchers have postulated that a pulsating/non-static force might move teeth more rapidly and ease the discomfort of traditional orthodontics. Intermittent stimulation of the periodontal tissue by resonance mechanical vibration was used to accelerate experimental tooth movement in rats in a study performed on a sample of 42 wistar rats with an experimental duration of 21 days. The results showed a significant increase in the rate of the tooth movement when compared to non-vibration control sample. Other studies performed using rabbits have shown that the use of cyclic forces could significantly improve dental straightening compared to static loading.

There currently exists devices for vibrating the teeth during orthodontic treatment. One device uses a bulky external power source to power one to four small motors. This device was modified to employ pulsating fluids that moved with the chewing motion of the jaw. The device includes a radio receiver with a speaker that vibrates in response to radio wave which in turn exerts a pulsating force on the tooth. These devices are mounted on an external headdress and then connected directly to the teeth by its intraoral portions. This makes them difficult and expensive to build, as well as uncomfortable to use, thus reducing patient compliance.

A hand-held device to treat periodontal disease has been proposed. The mouth piece has a pierced malleable dental brass plate which is adaptable to the user's bite. An external vibrator delivers motion to the mouthpiece and thus the user's teeth. However, the external vibrator uses an external power source.

Another proposed device is a hand-held tooth vibrator with an exterior motor connected to a vibrating mouthpiece portion. The vibration induced by the device increases the blood flow which increases the user's discomfort. In another device, the bulkiness of the power actuator of the device may adversely affect patient comfort and patient compliance with the treatment. The device is mounted on brackets which reduce the effectiveness of conveying the vibration forces to the teeth. A complex intra-oral vibrating mouthpiece was introduced with a design to fit over the teeth in order to target the vibrational forces to the teeth. This complexity makes it relatively expensive to manufacture. It also must be noted that a factor reducing the effectiveness of the aforementioned devices is that the vibration is not optimized in terms of frequency and amplitude for bone remodeling.

Another device was presented with an aim to achieve a faster rate of tooth movement by enhancing bone remodeling using pulsating forces. This device, which is called AcceleDent owned by OrthoAccel, describes both intra-oral and extra-oral dental vibrators with processors to capture and transmit patient usage information. Due its improved bite plate, this device is more effective in conveying vibrational forces to the teeth than the previously-described devices. The device has an improved design for force and frequency which enhances the comfort level and patient compliance. AcceleDent is prescribed to be used twice daily for 10 minutes during orthodontic treatment and can be used as an adjunct to fixed appliance or aligner treatment. Studies were performed at the University of Texas-Houston to examine the effectiveness and safety of vibration in humans for orthodontic tooth movement. Results showed an increased rate of tooth movement by 70% compared to previous publications as well as less root resorption. No serious harmful events were reported in their findings as a result of the treatment. This reaffirms the safety associated with vibration-based therapy as well as the AcceleDent device. In comparison to previous approaches, AcceleDent is also more compact, since it does not require the patient to wear a head-dress mount. According to the study, an output force of 25 grams with a frequency of 30 Hz was equally [symbol] ted among both, the lower and upper jaws. The device provides vibration to all teeth, which makes it bulky.

As can be seen from the art, there is a long-felt need for a vibratory device designed with improved patient comfort for better patient compliance and enhanced efficacy to shorten the treatment time.

### BRIEF SUMMARY OF THE DISCLOSURE

The present disclosure provides an intra-oral vibrating device that is contained in the mouth (not visible). This device is capable of shortening and increasing the effectiveness of the orthodontic treatment. Shorter treatment time allows for devotion of time and resources from dental practices to each individual case. Therefore, the device is minimally invasive which increases the patient compliance during the treatment. Embodiments of the device utilize piezoelectric actuators that can be excited by a voltage function generator (signal generator) given a specific frequency and amplitude. The vibrating part of the device may be composed of a bio-compatible smart material such as polyvinylidene fluoride (PVDF). PVDF is an advantageous piezoelectric polymer because of its high flexibility, biocompatibility, and low cost. These features make PVDF attractive for energy conversion applications involving micro electric-mechanical devices, electromechanical actuators, and energy harvesters. The device is attached to an orthodontic appliance such as, for example a positioner or aligner, to provide cyclic forces to a specific part of the appliance which in turn transmits these forces to the targeted teeth. An advantage of this method is that the device can be adjusted and repositioned in different locations of the tooth aligner. This allows for patient-specific targeting of tooth movement during treatment. An embodiment of the present device incorporates vibrating portion, an intraoral voltage function generator, a battery, and a processor all in one device. This allows for more compact design compared to the cumbersome designs currently available. This may be preferred as it would minimize drooling, which tends to occur if the lips are held open by an extraoral parts.

The presently-disclosed device can induce vibration to accelerate the rate of orthodontic tooth movement and thus reduce the duration of the orthodontic treatment. Generally, application of cyclic loading (vibration) reverses bone loss, stimulates bone mass, induces cranial [symbol] and accelerates tooth movement. This reduces the pain and discomfort associated with orthodontic treatment and also enhances patient compliance with the treatment. Vibration has the further advantage of minimal side effects in comparison to medicinal treatments.

### DESCRIPTION OF THE DRAWINGS

For a fuller understanding of the nature and objects of the disclosure, reference should be made to the following detailed description taken in conjunction with the accompanying drawings, in which:

FIG. 1A is a diagram of an embodiment of the disclosed device attached to a tooth aligner;

FIG. 1B depicts a diagram of an exemplary U-shaped actuator/vibrator;

FIG. 2 is a 3D view of an aligner and a model of a lower jaw;

FIG. 3 is a diagram showing vibration induced in a tooth by actuators.

FIG. 4 is a chart showing a method according to an embodiment of the present disclosure;

FIG. 5 depicts another exemplary U-shaped PVDF actuator/vibrator in e₃₁ actuation mode with an external electric field E along the material thickness;

FIG. 6 is a free body diagram of a statically indeterminate rod;

FIG. 7 is a graph showing exact (i.e., actual) and FEM axial force Vs voltage at e₃₁ actuation mode;

FIG. 8 is a graph of a force frequency response function e₃₁ actuation mode;

FIG. 9 is a graph showing analytically and numerically obtained cyclic forces in grams per unit voltage at 30 Hz at e₃₁ actuation mode;

FIG. 10 is a graph showing a variation of axial force with PVDF actuator length at different voltage inputs at e₃₁ actuation mode;

FIG. 11 is a graph showing a variation of axial force with PVDF actuator width at different voltage inputs at e₃₁ actuation mode;

FIG. 12 is a graph showing an axial force comparison by FEM at full matrix actuation and e₃₁ actuation mode;

FIG. 13A is a diagram of an exemplary device of the present disclosure attached to a tooth aligner, and showing the coordinate system;

FIG. 13B is a free body diagram of an exemplary curvy and U-shaped structure of the PVDF actuator;

FIG. 14 shows the normal stresses building up at fixed-fixed ends of the right and left PVDF actuators in Pascals;

FIG. 15 shows the total deformation at the free ends of the right and left PVDF actuators in meters;

FIG. 16 depicts another embodiment of the U-shaped PVDF actuator;

FIG. 17 is a graph showing a total axial force comparison between actual and analytical U-shaped PVDF actuator;

FIG. 18 depicts an embodiment of a single-layer PVDF actuator;

FIG. 19 is a graph showing the total axial force comparison between actual and analytical single layer PVDF actuator; and

### DETAILED DESCRIPTION OF THE DISCLOSURE

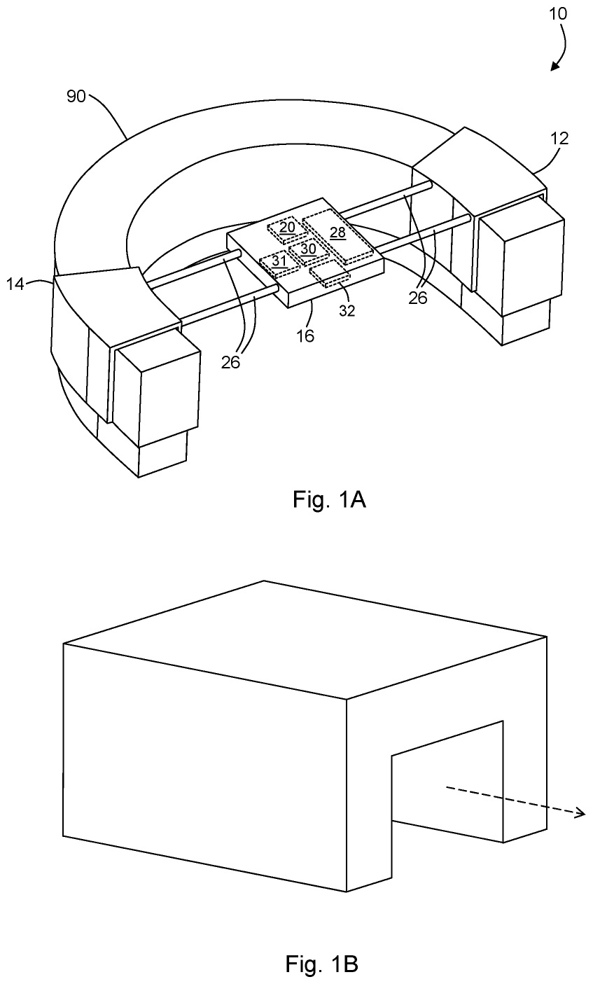

With reference to FIG. 1A, the present disclosure may be embodied as a vibrational device 10 for attachment to an orthodontic appliance 90. For example, the device 10 may be attached to a tooth positioner or aligner. The device 10 includes a first actuator 12 configured to be attached to the orthodontic appliance 90 at a location proximate to a dentition (e.g., a tooth or teeth being aligned). In this way, the first actuator 12 can impart vibratory forces into the dentition (e.g., a target tooth). While the disclosure may refer to a target tooth (a tooth being aligned), such reference is for convenience and it should be noted that in each case more than one tooth may be targeted. Similarly, reference to target teeth is intended to include multiple teeth or a single, targeted tooth. The first actuator 12 may be a piezoelectric actuator. For example, the first actuator 12 may comprise a bio-compatible piezoelectric material such as, for example, polyvinylidene fluoride (PVDF). While reference is made herein to a PVDF actuator, it should be noted that the disclosure includes actuators made from other bio-compatible piezoelectric materials. In addition to its ease of manipulation and satisfactory mechanical strength, the biocompatibility of PVDF makes it excellent option for intraoral vibrating devices.

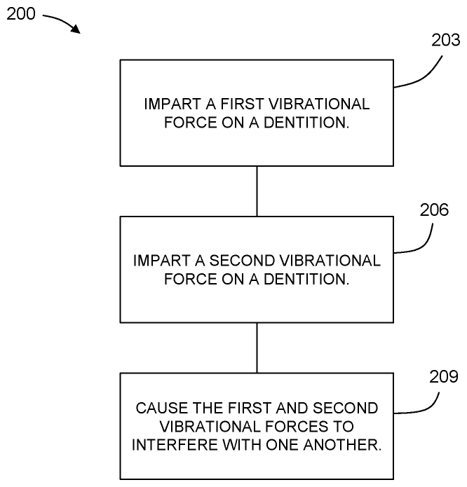

The device 10 may comprise more than one actuator. For example, the device 10 may comprise a second actuator 14 configured to be attached to the orthodontic appliance 90 at a location [symbol] te to the dentition 95. The second actuator 14 may be a piezoelectric actuator. For example, the second actuator 14 may comprise a bio-compatible piezoelectric material such as, for example, PVDF. The second actuator 14 may be made from the same material as the first actuator 12 or a different material. One of skill in the art will appreciate that more than two actuators may be used in embodiments of the present disclosure—see, for example, actuators 112, 114, 116 of FIG. 3.

By proximate to the dentition, the first actuator and second actuator may be positioned to be in direct contact with the dentition or indirect contact with the dentition. For example, the actuators may be in indirect contact with the dentition by attachment to an orthodontic appliance. For example, the actuators may be configured to be attached (for example, removably attached) to an aligner. A configuration where the actuators are removably attached to an appliance allows the device to be installed only when needed for treatment, thereby improving patient comfort between treatments. In some embodiments, the actuators may be located between the appliance and the dentition. In some embodiments, the actuators are disposed through the appliance (e.g., through the aligner) such that the actuators may be in direct contact with the dentition.

In some embodiments, the first and second actuators 12, 14 may be smaller in size than a tooth (see, e.g., actuators 112, 114, 116 of FIG. 3). In some embodiments, the actuators are similar in size to a target tooth. In some embodiments, the actuators are larger in size than a tooth and, in some examples, may be sized to act on more than one tooth. In some embodiments, the actuators are U-shaped such that the actuators will fit over the dentition—e.g., on a lingual side, a labial side, and an occlusal surface. The actuators may be the same size as one another or a different size. As used herein with reference to an actuator, unless otherwise stated, the term “size” may refer to any one or more dimensions of an actuator (for example, as applicable, length, width, height, thickness, circumference, diameter, etc.), combinations of dimensions (area, volume, cross-sectional area, tooth-contacting area, etc.)

In some embodiments, the first actuator 12 may be positioned proximate to a first target tooth (for example, a mandibular left molar) and the second actuator 14 may be proximate to a second target tooth (for example, a mandibular right molar). In another embodiment, for example the device 110 depicted in FIG. 3, more than one actuator may be positioned proximate the same targeted tooth. In some embodiments, more than one actuator may be formed in the same [symbol] ectric member by patterning an electrode layer used to excite the piezoelectric material (further described below). Some embodiments may combine these configurations, for example, including multiple actuators adjacent to each of multiple teeth.

The actuators are excited by a signal generator causing the actuators to produce vibration which apply cyclic forces on the targeted teeth. The device 10 further comprises a signal generator 20 in electrical communication with the first and second actuators 12, 14. The signal generator 20 is configured to provide a first drive signal to the first actuator 12 and a second drive signal to the second actuator 14 to create vibrational forces which may be imparted into the dentition. The vibrational forces created by the actuators may correspond to the drive signals such that, for example, an increased voltage may cause an increased amplitude of vibration and/or a frequency of the voltage change may cause a vibrational frequency in the actuator. In this way, a frequency, amplitude, and/or phase of each vibrational force may be controlled by controlling the signal provide by the signal generator 20.

Each drive signal may differ from the other signal in any parameter such as phase, amplitude, time of actuation, etc. In some embodiments, the first drive signal may be different from the second drive signal. For example, the first drive signal may be out of phase from the second drive signal. As such, the signal generator 20 may have a first signal generator and a second signal generator. In some embodiments, the signal generator may have additional components to alter the first drive signal and/or the second drive signal so as to create a difference in the signals. For example, the signal generator 20 may comprise a delay circuit in order to create a phase difference between the drive signals. For example, where more than one actuator is present in a device, a first signal generator may provide a signal to a first actuator 12 and a second signal generator may provide a signal to a second actuator 14. In some embodiments, the drive signal from a signal generator 20 may be modified without the need for a second signal generator (for example, by imposing a delay to change a phase).

As mentioned above, previous studies have demonstrated a beneficial effect using a frequency of 30 Hz, and embodiments of the disclosure are presented using 30 Hz. However, one of skill in the art will appreciate that any other frequency (higher or lower than 30 Hz) having a beneficial effect can be used in the present disclosure. Similarly, a voltage of 100 Volts is used [symbol] out the examples of the present disclosure, but one having skill in the art will appreciate that other voltages having a beneficial effect may be used (higher or lower than 100 Volts). Also, forces ranging from 3 grams to 25 grams are used in this disclosure to for illustration, but other forces having a beneficial effect may be used with a value within the range, lower than this range, or higher than this range.

The signal generator 20 may be electrically connected to the actuator(s) by one or more electric wires 26. In some embodiments, the wires 26 are rigid. The wires 26 may be, for example, rigid stainless steel wires. One of skill in the art will appreciate that other types of biocompatible, electrically conductive materials can be used in embodiments of the present disclosure.

The device further comprises an energy storage device 28, such as a battery or a supercapacitor, for powering the signal generator 20 (which, in turn, powers the actuators). The energy storage device 28 may be rechargeable and/or replaceable. One having skill in the art will appreciate that any biocompatible energy storage device suitable for intraoral use may be used.

The device 10 may include a processor 30 in electrical communication with the signal generator 20. In this way, the processor 30 may control the signal generator 20 to define the waveform of the first and second drive signals. The processor 30 may additionally perform functions such as recording patient compliance, monitoring and reporting device status, etc. (further detailed below). In some embodiments, the processor includes memory and/or a separate memory 31 may be provided. In some embodiments, memory may be used to store data related to patient compliance, device status, etc. In some embodiments, computer-readable instructions may be stored on such a memory for programming the processor 30. For example, the memory may store instructions such that the processor 30 begins a vibrational treatment at a programmed time of the day (or multiple times), for a programmed duration, and having a programmed configurations for the drive signals. In some embodiments, the device 10 is activated manually by the user. For example, the device 10 may further include a switch, button, haptic sensor, or the like for manual activation.

The device 10 may include a transceiver 32, for example, a Bluetooth transceiver, for communication with other devices, such as, for example, extra-oral devices. In this way, a device [symbol] a smartphone, a tablet, or the like, may be used to control the device 10. For example, a user may use a smartphone connected to the device via the transceiver 32 to initiate a vibrational treatment, select a frequency, select a magnitude, and/or select a duration. The transceiver 32 may be in communication with the processor 30 so as to provide wireless connection thereto. For example, in some embodiments, a user may be able to select from a range of frequencies and/or forces and transmit the selection to the processor 30 of the device 10 by way of the transceiver 32. Similarly, the transceiver 32 may provide external (e.g., wireless) access to the processor 30 and/or memory for collection of, for example, data and usage information. Monitoring usage may be important to give clinicians insights on patient compliance.

A housing 16 may be provided to contain the signal generator 20, the processor 30, the transceiver 32, memory 31, and/or the energy storage device 28 (as applicable), or any combination of these (and/other) components. The housing 16 may be sealed such that it is waterproof. The housing 16 may be, for example, a pre-formed housing into which the components are inserted. The housing 16 may be a coating, such as an epoxy coating which is formed around the components. The housing 16 may be shaped so as to improve patient comfort. The housing unit can also include components such as a charging port, indicator lights, or access to the battery.

### Vibration Focusing

With reference to FIG. 3, embodiments of the presently-disclosed device may be configured to further localize the vibrational excitation. As described above, multiple actuators may be provided for a dentition. FIG. 3 shows a first actuator 112, a second actuator 114, and a third actuator 116 positioned proximate to a targeted tooth 99. For example, the multiple actuators may be formed by patterning the electrodes of a piezoelectric material covering the tooth. Drive signals can be applied to each actuator where each drive signal has, for example, the same frequency but different amplitude and/or phase from the other drive signals (e.g., generating vibrations having corresponding frequencies, amplitudes, and phases in the actuators). In this way, the vibrational waves generated by each actuator can be caused to interfere with one another, thereby causing localized areas of greater (and/or lower) amplitude. This wave focusing allows a notable amount of vibrational force on those parts of a tooth or jaw bone that are involved in bone growth (to expedite the orthodontic process) while inducing reduced amounts of vibration on other (non-targeted) parts [symbol] oth or jaw bone. This capability may be created by patterning the electrode layer on the piezoelectric tooth cover for applying different voltages to different parts of the cover. The applied voltages to the patches may have the same frequency but different amplitudes and different phases. The interactions between vibrational forces create increased intensity (increased with respect to the individual force intensities created by each actuator) in a targeted part of a tooth or jaw bone while other non-targeted parts of the tooth or jaw bone experience a lower intensity level of vibration (lower than the intensity induced in the targeted part). The use of such embodiments may reduce the overall level of vibration produced by the device, thereby reducing the power consumption of the device and at the same time increase the patient's comfort.

Although the electrodes may be patterned as illustrated in FIG. 3 for vibration focusing, they can be used for regular tooth growth acceleration as well. For regular excitations the actuators may be connected in parallel and excited by the signal generation circuits.

In a particular embodiment, the presently-disclosed vibrational dental device may be configured for attachment to an aligner and the exemplary embodiment includes: (1) a harmonic function generator (i.e., signal generator) and processor powered by (2) an intraoral high-voltage, low-current battery, and (3) two PVDF vibrators/actuators located at the tooth aligner where the targeted teeth are being aligned (see, for example, FIG. 1A). The PVDF actuators are connected to the signal generator by way of rigid wires. Stainless steel wires may be chosen for their formability, biocompatibility, environmental stability, stiffness, resilience, and low cost. The wires may be adjustable such that a first actuator and/or a second actuator can be moved to different locations along the tooth aligner. Various embodiments of the presently-disclosed device may be configured for use with the upper jaw, the lower jaw, or adjustable for use with either jaw or portion thereof. The same device can also be adjusted for either the upper or lower jaw. Components such as the battery and the signal generator may be disposed in a waterproof housing. The housing may be centrally located between the first and second actuators and held in position by way of the rigid wires. In this way, for example, the device may be attached to an upper jaw aligner with the actuators positioned at opposite sides of the dental arch and the housing located centrally near the roof of the mouth.

In another embodiment, the present disclosure may be embodied as a method 200 for enhancing orthodontic treatment (see, e.g., FIG. 4). The method 200 includes imparting 203 a first vibrational force on a dentition using a first actuator. A second vibrational force is imparted 206 on the dentition using a second actuator. The first and second vibrational forces are configured 209 to interfere with one another to cause an increased amplitude at a predetermined location in the dentition.

Without intending to be bound by any particular theory, further details of embodiments of the present disclosure and a detailed description of the theory (including analytical model) are provided below. The following description describes illustrative embodiments, not intended to be limiting.

### Exemplary Device Configuration and Electromechanical Model of PVDF

The device coupled with a patient's current method of tooth alignment, such as an aligner or retainer. Tooth aligners, are custom made for each patient using a digital treatment plan where a software predicts the movement of the teeth throughout treatment. Several aligners are used sequentially by the patient during the entire course of treatment. Each aligner applies static pressure to the patient's targeted teeth, causing them to move (i.e., straighten) under the applied pressure. The realignment process is accelerated by applying vibrational (cyclic) forces. For example, vibrational forces may be applied for at least 20 minutes per day, divided into two sessions with 10 minutes for each session. Studies have shown that this exemplary protocol accelerates dental remodeling by as much as 70%. The presently-disclosed device may be attached to the aligner to provide these cyclic forces to the targeted teeth. Such aligners are available in the market, such as Invisalign. Medical grade silicone rubbers are advantageous for the tooth positioner or tooth aligner since they have good transparency, strength, no taste and a comfortable feel. However, one of skill in the art will appreciate that other materials may be used to form such appliances.

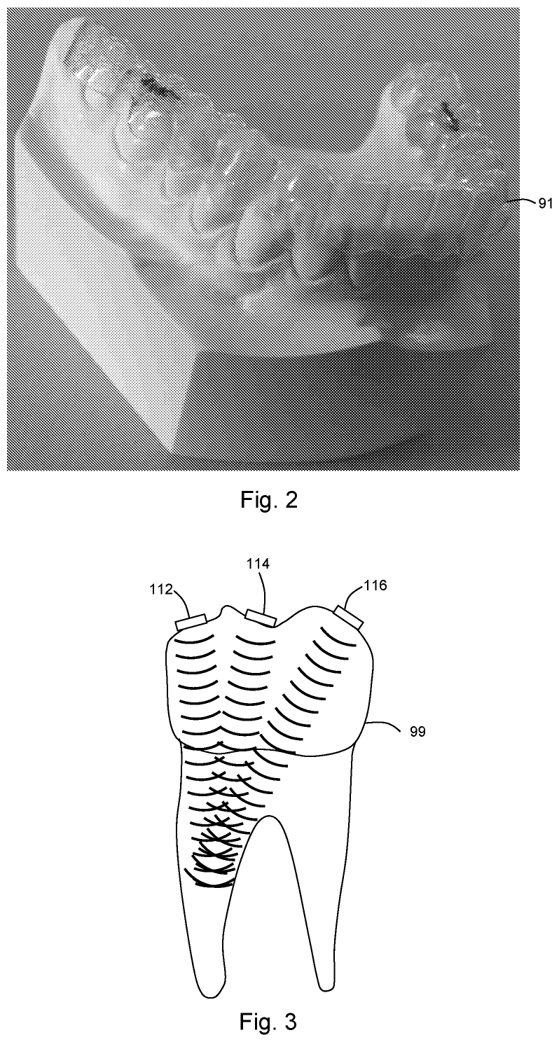

FIG. 2 shows a 3D view of an aligner 91 where the tooth shape is closely matched. It is generally U-shaped. The tooth aligner is designed to contact facial, lingual, and occlusal surfaces of the teeth and apply a corrective pressure to one or more teeth. Only the lower jaw is shown in FIG. 2.

In this illustrative analysis, each vibratory actuator is modeled to vibrate at 30 Hz and provide a force of 8.5 grams at 100 volts. An actuator was modeled as an elastic bar having a U-shaped cross-section and resting at the surface of the aligner (e.g., as depicted in FIG. 1A). The PVDF actuator is polarized in the z-direction along the actuator thickness. The patient bites on the actuators during the operation of the device, allowing the actuators to stretch (as the piezoelectric material is deformed) in the direction parallel to surface of the aligner. The cyclic forces of the device are the result of longitudinal vibrations of the structure. FIG. 1A shows a simplified aligner combined with the presently-disclosed device showing the PVDF vibrators (actuators) attached at specific locations of the aligner. It also illustrates the coordinates used throughout this paper to describe the general dynamic equations of motion. FIG. 1B shows an exemplary U-shaped actuator and the direction of the axial force.

The constitutive equations describing the piezoelectric property are based on the assumption that the total strain in the transducer is the sum of mechanical strain induced by the mechanical stress and the controllable actuation strain caused by the applied electric voltage. The axes are identified by numerals rather than letters, where ‘1’ corresponds to the x-axis, ‘2’ corresponds to the y-axis, and ‘3’ corresponds to the z-axis. Axis 3 is assigned to the direction of the initial polarization of the piezoceramic, and axes 1 and 2 lie in the plane perpendicular to axis 3.

The governing/characteristic electromechanical equations for a linear piezoelectric material can be written as:

Sᵢ=Eᵢⱼ^{E}Tⱼ+dₘᵢEₘ

Dₘ=dₘᵢTᵢ+εᵢₖ^{T}Eₖ (1)

The field variables are the stress components (T), strain components (S), electric field components (E), and the electric displacement components (D). ε^{T} is the Permittivity (F/m) and d is the matrix of piezoelectric strain constants (m/V). The indexes i, j=1, 2, . . . , 6 and m, k=1, 2, 3 refer to different directions within the material coordinate system, as follows:
# Axis
1 x
3 z
4 Shear around x
5 Shear around y
6 Shear around z

Equations (1) can be given in the matrix form as:

$$[ \begin{matrix}S \\ D\end{matrix} ] = [ \begin{matrix}{s}^{E} & d \\ {d}^{t} & {ɛ}^{T}\end{matrix} ] [ \begin{matrix}T \\ E\end{matrix} ] \qquad ( 2 )$$

where superscripts E and T represent that the respective constants are evaluated at constant electric field and constant stress, respectively, and superscript t stands for the transpose. The expanded form of Equation (2) is:

$$[ \begin{matrix}{S}_{1} \\ {S}_{2} \\ {S}_{3} \\ {S}_{4} \\ {S}_{5} \\ {S}_{6}\end{matrix} ] = [ \begin{matrix}{S}_{11}^{E} & {S}_{12}^{E} & {S}_{13}^{E} & {S}_{14}^{E} & {S}_{15}^{E} & {S}_{16}^{E} \\ {S}_{21}^{E} & {S}_{22}^{E} & {S}_{23}^{E} & {S}_{24}^{E} & {S}_{25}^{E} & {S}_{26}^{E} \\ {S}_{31}^{E} & {S}_{32}^{E} & {S}_{33}^{E} & {S}_{34}^{E} & {S}_{35}^{E} & {S}_{36}^{E} \\ {S}_{41}^{E} & {S}_{42}^{E} & {S}_{43}^{E} & {S}_{44}^{E} & {S}_{45}^{E} & {S}_{46}^{E} \\ {S}_{51}^{E} & {S}_{52}^{E} & {S}_{53}^{E} & {S}_{54}^{E} & {S}_{55}^{E} & {S}_{56}^{E} \\ {S}_{61}^{E} & {S}_{62}^{E} & {S}_{63}^{E} & {S}_{64}^{E} & {S}_{65}^{E} & {S}_{66}^{E}\end{matrix} ] [ \begin{matrix}{T}_{1} \\ {T}_{2} \\ {T}_{3} \\ {T}_{4} \\ {T}_{5} \\ {T}_{6}\end{matrix} ] + {[ \begin{matrix}{d}_{11} & {d}_{12} & {d}_{13} & {d}_{14} & {d}_{15} & {d}_{16} \\ {d}_{21} & {d}_{22} & {d}_{23} & {d}_{24} & {d}_{25} & {d}_{26} \\ {d}_{31} & {d}_{32} & {d}_{33} & {d}_{34} & {d}_{35} & {d}_{36}\end{matrix} ]}^{t} [ \begin{matrix}{E}_{1} \\ {E}_{2} \\ {E}_{3}\end{matrix} ] \qquad ( 3 )$$

The shear stresses can be expressed in more common notation used in literature as:

T₄=τ₂₃

T₅=τ₃₁

T₆=τ₁₂

and the shear stresses can be expressed:

S₄=γ₂₃

S₅=γ₃₁

S₆=γ₁₂

The electric displacement is expressed as:

$$[ \begin{matrix}{D}_{1} \\ {D}_{2} \\ {D}_{3}\end{matrix} ] = [ \begin{matrix}{d}_{11} & {d}_{12} & {d}_{13} & {d}_{14} & {d}_{15} & {d}_{16} \\ {d}_{21} & {d}_{22} & {d}_{23} & {d}_{24} & {d}_{25} & {d}_{26} \\ {d}_{31} & {d}_{32} & {d}_{33} & {d}_{34} & {d}_{35} & {d}_{36}\end{matrix} ] [ \begin{matrix}{T}_{1} \\ {T}_{2} \\ {T}_{3} \\ {τ}_{23} \\ {τ}_{31} \\ {τ}_{12}\end{matrix} ] + [ \begin{matrix}{ɛ}_{11}^{T} & {ɛ}_{12}^{T} & {ɛ}_{13}^{T} \\ {ɛ}_{21}^{T} & {ɛ}_{22}^{T} & {ɛ}_{23}^{T} \\ {ɛ}_{31}^{T} & {ɛ}_{32}^{T} & {ɛ}_{33}^{T}\end{matrix} ] [ \begin{matrix}{E}_{1} \\ {E}_{2} \\ {E}_{3}\end{matrix} ] \qquad ( 4 )$$

Equation (1) can be written in different format relating the stress to the strain as the following:

{T}=[c^{E}]{S}−[e]{E} (5)

where [c^{E}] is stiffness matrix evaluated at constant electric field and [e] is the piezoelectric constants matrix relating stress/electric field.

Equation (1) is converted to Equation (5) by performing the following manipulations:

{S}=[s^{E}]{T}+[d]{E}

[s^{E}]{T}={S}−[d]{E} (6)

{T}=[s^{E}]⁻¹{S}−[s^{E}]⁻¹[d]{E} (6)

Therefore,

[c^{E}]=[s^{E}]⁻¹

[e]=[s^{E}]⁻¹[d] (7)

Given the Young's modulus of elasticity Y and Poisson's ratio v in Table 1, the PVDF compliance matrix [s_{E}] at constant electric field can be populated as follows:

$$[ {s}^{E} ] = [ \begin{matrix}1 / Y & - v / Y & - v / Y & 0 & 0 & 0 \\ - v / Y & 1 / Y & - v / Y & 0 & 0 & 0 \\ - v / Y & - v / Y & 1 / Y & 0 & 0 & 0 \\ 0 & 0 & 0 & 1 / G & 0 & 0 \\ 0 & 0 & 0 & 0 & 1 / G & 0 \\ 0 & 0 & 0 & 0 & 0 & 1 / G\end{matrix} ] ( {m}^{2} / N )$$

[symbol]

is the modulus of rigidity defined as

$$\frac{Y}{2 ( 1 + v )} .$$

The PVDF piezoelectric stress constants matrix [d]^{t} is defined as the following:

$${[ d ]}^{t} = [ \begin{matrix}0 & 0 & 0 & 0 & 0 & 0 \\ 0 & 0 & 0 & 0 & 0 & 0 \\ 23 & 3 & - 33 & 0 & 0 & 0\end{matrix} ] \times {10}^{- 12} ( m / V )$$

PVDF dielectric Matrix [ε^{T}]:

$$[ {ɛ}^{T} ] = [ \begin{matrix}9 & 0 & 0 \\ 0 & 9 & 0 \\ 0 & 0 & 9\end{matrix} ] \times 8.854 \times {10}^{- 12} ( F / m )$$

Using Equation (7), both the stiffness matrix evaluated at constant electric field and the piezoelectric constants matrix relating stress/electric field can be obtained as the following:

$$\begin{matrix}[ {c}^{E} ] = [ \begin{matrix}2.7 & 1.154 & 1.154 & 0 & 0 & 0 \\ 1.154 & 2.7 & 1.154 & 0 & 0 & 0 \\ 1.154 & 1.154 & 2.7 & 0 & 0 & 0 \\ 0 & 0 & 0 & 0.77 & 0 & 0 \\ 0 & 0 & 0 & 0 & 0.77 & 0 \\ 0 & 0 & 0 & 0 & 0 & 0.77\end{matrix} ] \times {10}^{9} ( N / {m}^{2} ) & ( 8 ) \\ [ e ] = [ \begin{matrix}0 & 0 & 0 & 0 & 0 & 0.0273 \\ 0 & 0 & 0 & 0 & 0 & - 0.0035 \\ 0 & 0 & 0 & 0 & 0 & - 0.0588 \\ 0 & 0 & 0 & 0 & 0 & 0 \\ 0 & 0 & 0 & 0 & 0 & 0 \\ 0 & 0 & 0 & 0 & 0 & 0\end{matrix} ] ( \frac{N}{m V} ) & ( 9 )\end{matrix}$$

From Equation (9), the following are obtained:

$${e}_{31} = 0.0273 ( \frac{N}{mV} ) \\ {e}_{32} = - 0.0035 ( \frac{N}{mV} ) \\ {e}_{33} = - 0.0588 ( \frac{N}{mV} ) \qquad ( 10 )$$

Table 1 shows the material properties of piezoelectric PVDF material.

TABLE 1
Material properties of piezoelectric PVDF material

| | | | | | |
|---|---|---|---|---|---|
| Density (kg/m3) | 1780 | Poisson ratio | 0.3 | Young's | 2.0 |
| | | | | modulus (GPa) | |

### Electromechanical Model of PVDF Actuator at e₃₁ Actuation Mode

FIG. 4 illustrates an electric field (+E) in the direction of the material thickness of a single U-shaped PVDF actuator. A positive electric field is defined as the same direction as the polarization. Theoretical analysis based on the distributed parameter model. Piezoelectric actuation behavior is simulated using ANSYS Finite Element Method (FEM) software to validate the analytical model.

The process of deriving the electromechanical model begins with assuming that the PVDF actuator is poled along the thickness in the z-axis, the stress and strain are in the direction of the actuator length, l in the x-direction. The energy method can be used to model the dynamics the system. The electromechanical governing equation can be derived using Hamilton's principle. According to this principle, variation of the functional is taken with respect to time. The functional used in Hamilton's principle is called the Lagrangian (L) and is defined as:

L=K+Wₑ* (11)

where K is the kinetic energy stored in the bar and Wₑ* is the electrostatic energy stored in the PVDF actuators. For an elastic bar of length l, width b, mechanical stiffness constant under a constant electric field c₁₁^{E}, and mass density ρ with cross-sectional area A, the absolute displacement of the PVDF actuator at any point x along the bar in the x-axis direction is denoted by u(x,t) which can be solved for using the method of separation of variables by imposing infinite series of Eigen functions, the solution is written as:

$$u ( x , t ) = {\sum }_{n = 1}^{∞} {U}_{n} ( x ) {η}_{n} ( t ) \qquad ( 12 )$$

where the function U(x) represents the normal mode shape and η(t) is the temporal function. Each of the terms in Lagrangian are related to the states as follows:

$$K = \frac{1}{2} {\int }_{0}^{l} ρ {A ( \frac{d u}{dt} )}^{2} dx \\ {W}_{e}^{*} = - \frac{1}{2} {\int }_{0}^{l} {c}_{11}^{E} {A ( \frac{d u}{dx} )}^{2} dx + {\int }_{0}^{l} A ( \frac{du}{dx} ) {e}_{31} {E}_{3} dx \qquad ( 13 )$$

where; e₃₁ is the piezoelectric constant at a constant stress, and E₃ is the electric field. The uniform electric field is written in terms of the voltage v(t) across the PVDF thickness h as

$$( {E}_{3} = \frac{- v ( t )}{h} ) .$$

Subscript 1 and 3 directions are coincident with x and z directions. According to Hamilton's principle, the variation of the functional taken with respect to time should be equal to zero as the following:

δ∫ₜ_{₁}^{t}^{₂}∫₀^{L}L dx dt=0 (14)

Which becomes:

$$δ {\int }_{{t}_{1}}^{{t}_{2}} ( \frac{1}{2} {\int }_{0}^{l} ρ {A ( \frac{du}{dt} )}^{2} dx - \frac{1}{2} {\int }_{0}^{l} {c}_{11}^{E} {A ( \frac{du}{dx} )}^{2} dx + {\int }_{0}^{l} A ( \frac{du}{dx} ) {e}_{31} {E}_{3} dx ) dt = 0 \qquad ( 15 )$$

Solving the above equations yields to:

$${\int }_{{t}_{1}}^{{t}_{2}} {\int }_{0}^{l} ρ A \frac{du}{dt} δ ( \frac{d u}{dt} ) dxdt + {\int }_{{t}_{1}}^{{t}_{2}} {\int }_{0}^{l} {c}_{11}^{E} A \frac{du}{dx} δ ( \frac{du}{dx} ) dxdt - {\int }_{{t}_{1}}^{{t}_{2}} {\int }_{0}^{l} \frac{{Ae}_{31}}{h} δ v ( t ) ( \frac{du}{dx} ) dxdt - {\int }_{{t}_{1}}^{{t}_{2}} {\int }_{0}^{l} \frac{{Ae}_{31}}{h} v ( t ) δ ( \frac{du}{dx} ) dxdt = 0 \qquad ( 16 )$$

The Euler-Lagrange equations of the dynamic system can be constructed at this point to obtain the dynamic governing equation:

$$ρ A \frac{{\partial }^{2} u ( x , t )}{\partial {t}^{2}} - {c}_{11}^{E} A \frac{\partial }{\partial {x}_{i}^{2}} - \frac{{Ae}_{31}}{h} - \frac{{Ae}_{31}}{h} v ( t ) \frac{d}{dx} [ H ( x ) - H ( x - l ) ] = 0 \qquad ( 17 )$$

where H(x) is the Heaviside function.

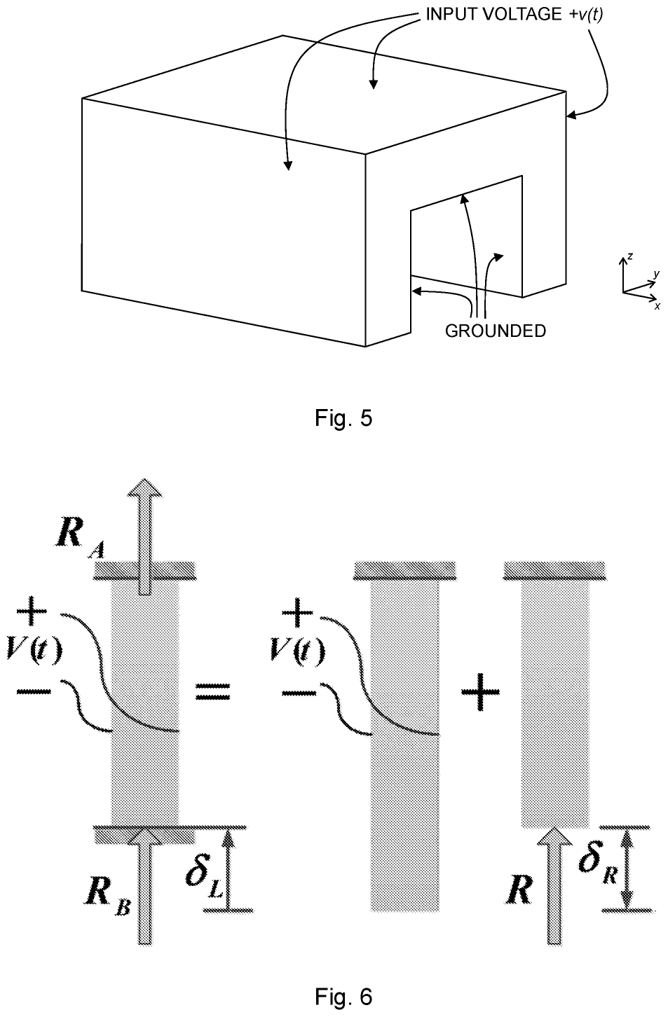

At this stage the analysis starts by evaluating the forces generated by the PVDF actuators on the targeted teeth for a range of constant voltage. The amount of force that can be generated from the PVDF actuators is determined by solving the statically indeterminate structures approach. The relations involving deformations are used with the equilibrium equations to determine the internal and reaction forces. The superposition method is used to solve for these forces where one of the reactions is designated as redundant and on eliminating the corresponding support. The redundant reaction is treated as an unknown load, which together with the other loads must produce deformations which agree with the original constrains. See FIG. 5. Where δ is the elongation of the bar.

The mode shapes corresponding to the natural frequency ωₙ of fixed-free rod can be expressed as:

$$U ( x ) = {C}_{n} sin ( \frac{( 2 n + 1 ) π x}{2 l} ) , \\ {ω}_{n} = \frac{( 2 n + 1 ) π c}{2 l} , \\ n = 1 , 2 … \\ c = \frac{\sqrt{{c}_{11}^{E}}}{\sqrt{ρ}} \qquad ( 18 )$$

where Cₙ is the modal constant. Imposing the orthogonality condition, the normal mode shapes are mass normalized, i.e., solving for the modal constant. Therefore, the mode shape U(x) can be mass normalized as the following:

$$ρ A {\int }_{0}^{l} {{U}_{n} ( x )}^{2} dx = 1 \\ {C}_{n} = \frac{\sqrt{2}}{\sqrt{L ρ A}} \qquad ( 19 )$$

Substitute equation (12) in the governing equation (17) and pre-multiply by the mode shape and then integrate the expression from zero to the length of the bar, and using the orthogonality of the mode shapes, the electromechanically coupled ordinary differential equation for the modal response of the bar can be obtained as:

$${\ddot{η}}_{n} + 2 ζ {ω}_{n} \dot{η} + {ω}_{n}^{2} η + \frac{{Ae}_{31}}{h} v ( t ) [ U ( l ) - U ( 0 ) ] = 0 \qquad ( 20 )$$

From equation (12), the axial force at the end of the bar in Newtons can be calculated as the following:

$$f ( l , t ) = \frac{{\sum }_{n = 1}^{∞} {U}_{n} ( l ) {η}_{n} ( t ) {c}_{11}^{E} A}{l} \qquad ( 21 )$$

The physical dimensions of the studied PVDF actuator are listed in Table 2.

TABLE 2
Piezoelectric PVDF actuator physical dimensions

| Properties | PVDF |
|---|---|
| Length (L) mm | 20 |
| Sum of cross section's outer edges length (b) mm | 31 |
| Thickness (h) mm | 4 |

The results of the axial forces generated by the PVDF actuator are illustrated in FIG. 5 when the PVDF is excited by a range of DC voltages. The analytical results are validated by finite element method using a commercially available FEM solver (namely ANSYS) at e₃₁ actuation mode. FIG. 5 also shows that the maximum reaction force generated by the PVDF of the test configuration was approximately 8.5 grams at 100 volts. In an exemplary embodiment, this force can be applied directly to at least four teeth. Since the system is linear, the force is linearly proportional with the applied voltage as can be concluded from FIG. 5.

In the case when a harmonic voltage is applied that can be presented as V sin (ωt), and if higher amplitude cyclic forces are required, then the PVDF actuator may be designed such [symbol] the natural frequencies of the actuator matches the excitation frequency of the harmonic voltage excitation.

FIG. 6 shows the force-frequency response function for a wide range of excitation frequencies obtained according to the following equation:

$$\frac{F ( l , ω )}{V ( ω )} = {\sum }_{n = 1}^{∞} \vert \frac{( {U}_{n} ( l ) - {U}_{n} ( 0 ) ) {Ae}_{31}}{h ( {ω}_{n}^{2} - {ω}^{2} + 2 j ζ {ωω}_{n} )} \vert , \qquad ( 22 )$$

As expected from FIG. 6, the force amplitude increases as the resonance frequency is approached and the force reaches its maximum. Nevertheless, due to the small size of the PVDF actuator, its natural frequencies are in orders of kilohertz. Therefore, exciting the PVDF actuators at one of its natural frequencies are not applicable. A previous study revealed that vibration at low frequency (30 Hz) and low amplitude force can accelerate the tooth bone remodeling much faster than a high-frequency, high amplitude force.

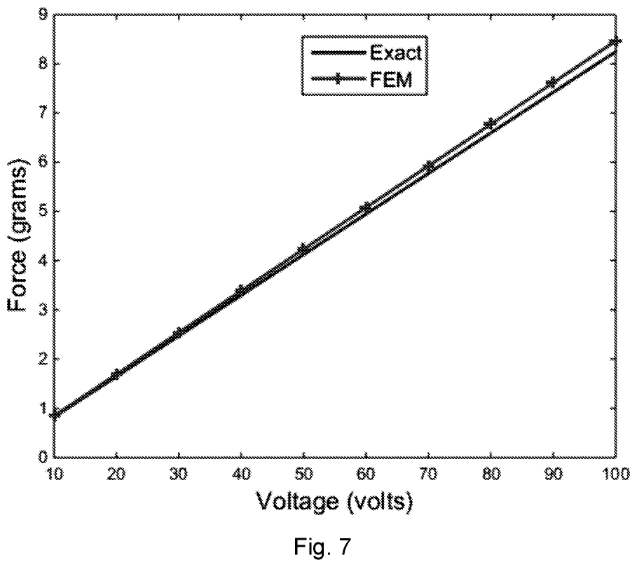

At this stage, a harmonic voltage at 30 Hz was applied and the cyclic forces generated by a single PVDF actuator were estimated. FIG. 7 shows the cyclic forces in grams per unit voltage obtained analytically and compared to the ones obtained using FEM. The comparison is done when only the piezoelectric stress constant e₃₁ is utilized. Both methods are in excellent agreement.

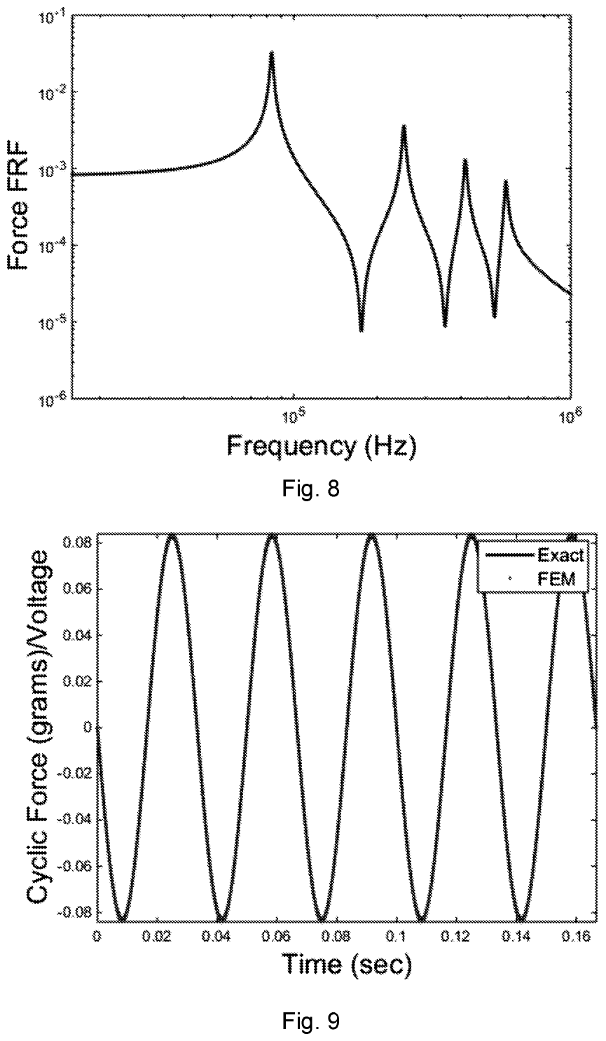

An examination of both FIG. 8 and FIG. 9 shows that the maximum amplitudes of the harmonic forces at different harmonic input voltages amplitudes at 30 Hz are equivalent to those obtained when applying DC voltage inputs as illustrated in FIG. 5. This is because the excitation frequency is much smaller than the first natural frequency of the PVDF actuator.

Therefore, the system can be approximated as a quasi-static system at a frequency much lower than the system natural frequencies, i.e., the system changes sufficiently slowly that the overall system can be considered in equilibrium at all times.

To enhance the amount of the total axial force, the effect of the actuator design parameters on the total force that can be produced was studied. Generally, the design parameters include length, thickness and, width of the actuator.

From equation (21), assuming the harmonic input voltage takes the shape of sine wave that can be presented as V sin (ω t), where V is the amplitude and ω is the excitation frequency equals to 30 Hz, the expression of the axial force in Newton's can simplified as the following:

$$f ( l , t ) = \frac{2 {e}_{31} {c}_{11}^{E}}{{l}^{2} ρ} {\sum }_{n = 1}^{∞} {( sin ( \frac{( 2 n + 1 ) π}{2} ) )}^{2} \frac{V}{\sqrt{{( {ω}_{n}^{2} - {ω}^{2} )}^{2} + 4 {ζ}^{2} {ω}_{n}^{2} {ω}^{2}}} \qquad ( 23 )$$

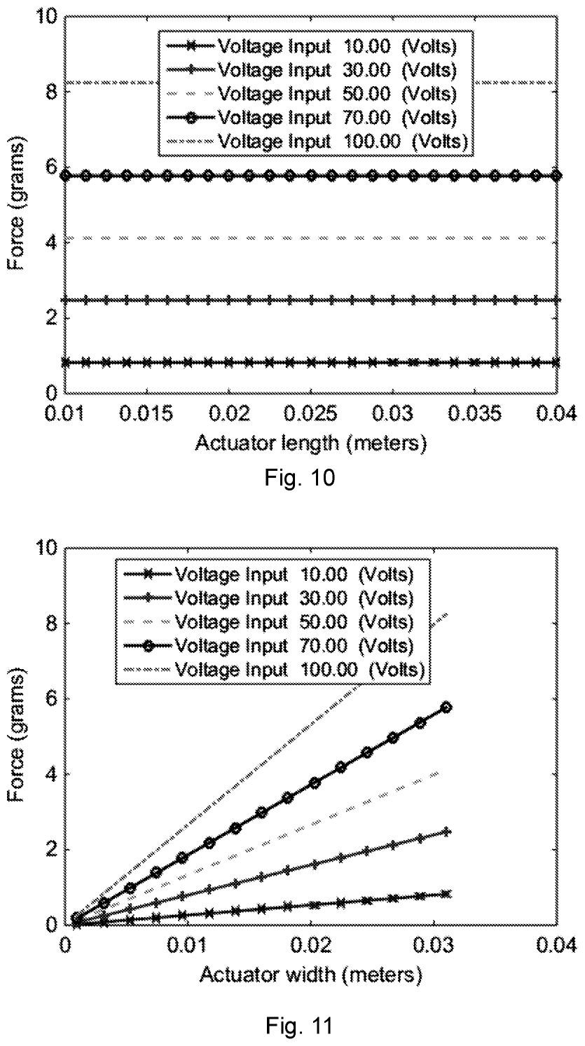

For a system that polarized in z-axis with e₃₁ actuation mode, it can be seen from Equation (23) that the thickness of the actuator has no effect on the axial force. Referring to the natural frequency expression in Equation (18), it can be concluded also from Equation (23) that the length of the actuator has very minor effect on the total axial force as can be seen in FIG. 10.

In the model, the thickness of the actuator was selected to be equal to 4 mm which was almost the same thickness as that of the aligner. The selection was made to keep the device light and compact. On the other hand, from Equation (23) it can be seen that the width of the actuator was linearly proportional to the total amount of axial force, as illustrated in FIG. 11.

### Electromechanical Model of PVDF Actuator Using the Full Actuation Matrix in Equation (3)

In this analysis, e₃₁, e₃₂, and e₃₃ actuation modes are all utilized. Basically, the effect of the e₃₂ implies that a strain and a stress are produced in the lateral direction namely, y-axis. This behavior is observed in plates. This behavior can be analytically modelled when the actuator is excited in e₃₁ and e₃₂ actuation mode. In this case, the normal stresses parallel to x-axis (T₁), y-axis (T₂), respectively, and the shear stress is in the xy-plane (T₆). The bending deformation of a plate assumes no coupling with shear deformation. In addition, due to the assumption that normals to the middle plane of the un-deformed plate remain straight and normal to the middle plane after deformation, the in-plane stresses of any point through the thickness of the PVDF plate in a state plane stress can be expressed as the following:

$$⌊ \begin{matrix}{T}_{2} \\ {T}_{6}\end{matrix} ⌋ = \frac{Y}{1 - {v}^{2}} [ \begin{matrix}1 & v & 0 \\ v & 1 & 0 \\ 0 & 0 & \frac{1 - v}{2}\end{matrix} ] [ \begin{matrix}{S}_{1} \\ {S}_{2} \\ {S}_{6}\end{matrix} ] - \frac{Y}{1 - {v}^{2}} [ \begin{matrix}1 & v & 0 \\ v & 1 & 0 \\ 0 & 0 & \frac{1 - v}{2}\end{matrix} ] [ \begin{matrix}0 & 0 & {d}_{31} \\ 0 & 0 & {d}_{32} \\ 0 & 0 & 0\end{matrix} ] [ \begin{matrix}{E}_{1} \\ {E}_{2} \\ {E}_{3}\end{matrix} ] \qquad ( 24 )$$

The expressions for the strains in Equation (24) can be found in the literature.

However, the Finite Element Technique was used to implement the full actuation matrix in Equation (3) using ANSYS. This was because implementing the full piezoelectric stress constants matrix [e] and analytically deriving the analytical electromechanical model of the U-shaped PVDF actuator complicates the model significantly. ANSYS provides a convenient way to obtain the results using the FEM. In ANSYS, the effect of the different piezoelectric constants at constant stress can be studied.

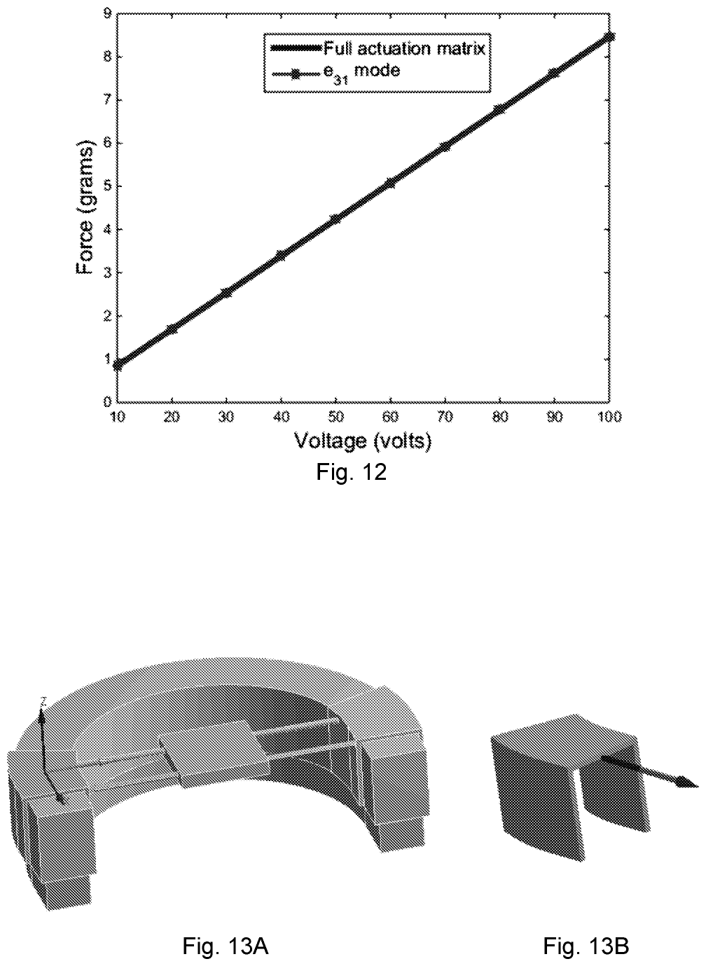

FIG. 12 compares the maximum axial force generated by the PVDF actuator at three actuation modes: full matrix actuation, e₃₁ and e₃₃ actuation modes, respectively. The maximum axial force that is obtained at full matrix actuation mode is perfectly matches the force obtained in the analytical and FEM models in e₃₁ actuation mode discussed previously. Therefore, the analytical model in e₃₁ actuation mode is sufficient to depict the system. It must be noted that, the axial force is applied to four teeth: two in the bottom and two on the top of the actuator as further discussed below. Since the system is linear, the force is linearly proportional with the applied voltage shown in FIG. 12.

The results for the full model are presented in FIG. 13A which illustrates the presently-disclosed device attached to both the aligner and the lower arc teeth. FIG. 13B illustrates the free body diagram of the exemplary curvy and U-shaped structure of the PVDF actuator. The arrow shows the direction of the axial force. The actual model of the PVDF actuator had the same physical dimensions listed in Table 2. This design maintains a thin and compact structure. A thinner actuator means lighter and compact design which enhance the patient comfort and compliance and avoid the other drawbacks the other available devices possess.

The coefficient of friction of a material is the measure of the sliding resistance of a material over another material. In the present example, the PVDF actuator's mating part is a standard aligner which usually is made of industrial plastic as can be seen in FIG. 2. To calculate the required force that is required to prevent sliding the actuators and aligner across each other, the required perpendicular/normal biting force between the mating sliding faces was calculated as the following:

$${F}_{n} = \frac{f ( l , t )}{μ} \qquad ( 25 )$$

where Fₙ is the normal force, μ is the co-efficient of friction and equals to 0.18 and f(l,t) is the axial force by the PVDF actuators. Therefore, in this example, the required biting force should be at least equal or larger than 48 grams force.

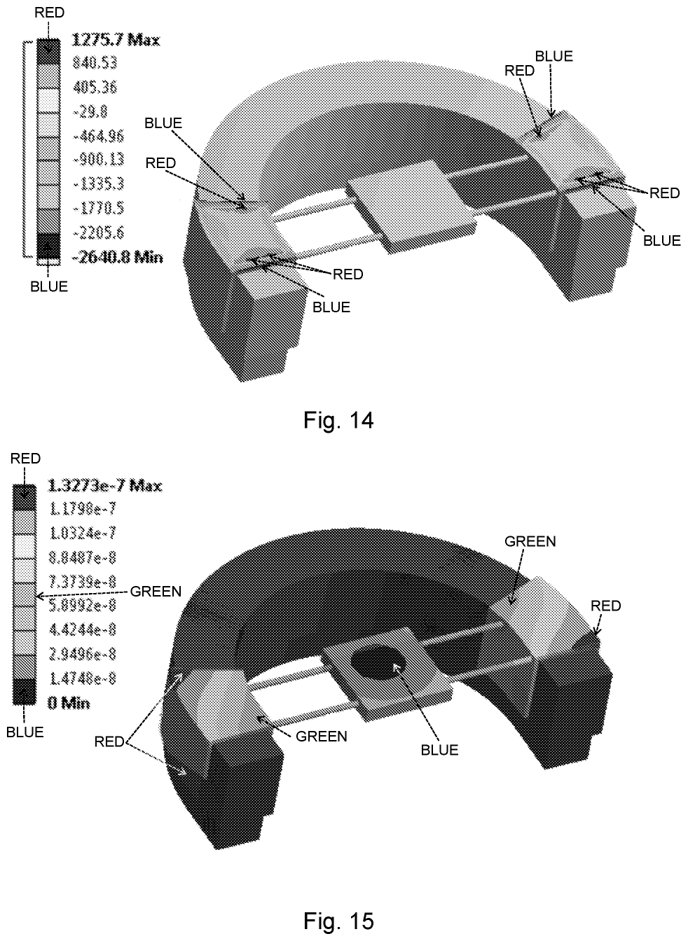

ANSYS was used to calculate the axial force at both fixed ends of the PVDF actuator. Also, the stress build-up at both fixed ends of the PVDF actuators was simulated (FIG. 14). FIG. 15 illustrates the total deformation at the free ends of the PVDF actuators.

### Exemplary Embodiment of a PVDF Actuator Using the Full Actuation Matrix in Equation (3)

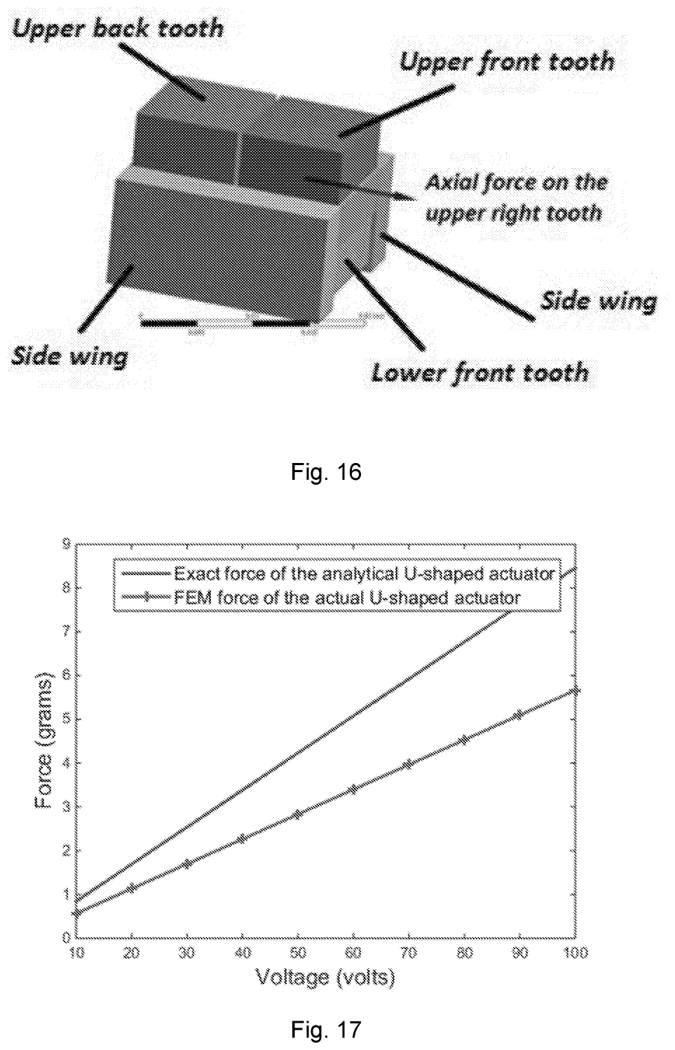

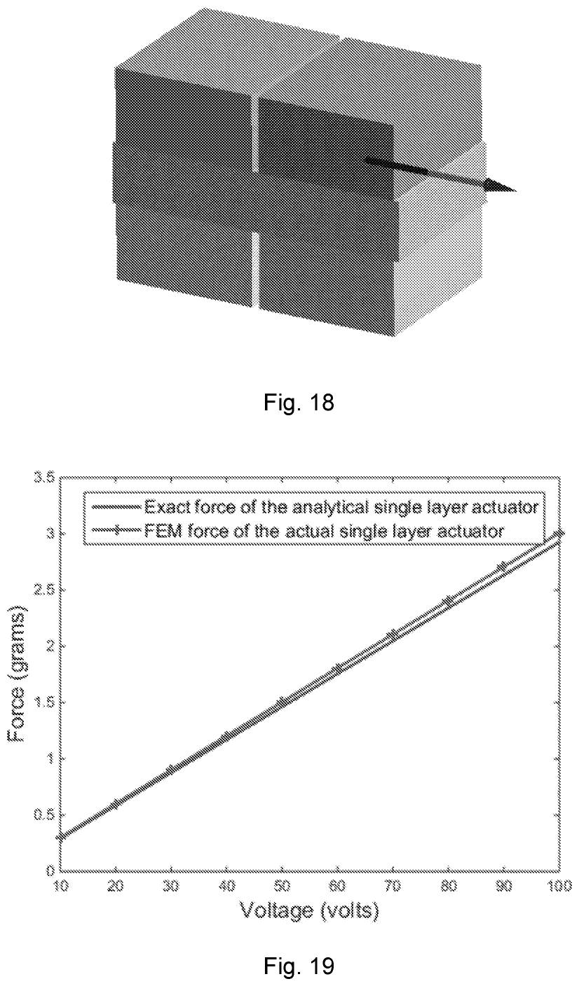

In this section a U-shaped model of the PVDF actuator as seen in FIG. 16 is further detailed. A single actuator may exert forces on the upper and lower teeth that are in contact. The forces exerted by the actuator are distributed among four teeth: two on top and another two in the bottom of the actuator. The axial force was calculated by FEM using ANSYS and the results were compared to those obtained analytically in the previous section for a fixed-fixed U-shaped actuator. FIG. 17 compares the sum of forces exerted by the actuator on the left or right upper and lower teeth with the axial force analytically obtained on either left or right fixed end of the U-shaped actuator discussed in the previous section. The discrepancies in the forces are due to the contribution of the side wings of the actuator in the total force. To explain this in more detail, FIG. 18 shows the actual single layer actuator without the side wings. FIG. 19 compares the sum of forces exerted by the single layer actual actuator on the left or right upper and lower teeth with the axial force analytically obtained on either left or right fixed end of the analytical single layer actuator. FIG. 19 [symbol] shows that the results are in very excellent agreement. Therefore, it was concluded that the side wings in the actual model do not have the effect on the total force as expected.

### CONCLUSION

An exemplary embodiment of the presently-disclosed dental vibrating device was designed to increase patient compliance and maintain a high level of comfort during the orthodontic treatment and to minimize the orthodontic treatment time as well. The vibrating part of the device may be composed of a bio-compatible smart material such as polyvinylidene fluoride (PVDF) piezoelectric actuators. The actuators were excited by a voltage function generator at 30 Hz and range of voltage amplitude. The device may be attached to an appliance such as a positioner or tooth aligner to provide cyclic forces to a specific part of the aligner which in turn transmits these forces to the targeted teeth. An exemplary device was modeled theoretically and numerically using ANSYS. The maximum force achieved was 7.3 grams applied to at least two teeth. The presently-disclosed device is compact in size compared the current market option. The vibrating component can be relocated and positioned at different locations of the tooth aligner. It may also combine the vibrating portion and an intraoral voltage function generator, battery, and processor all in one device. The presently-disclosed device is expected to minimize drooling, which tends to occur if the lips are held open by extra-oral parts in current devices. This also has the potential to enhance patient compliance with the treatment.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The following Statements provide embodiments and/or examples of the orthodontic treatment devices and methods orthodontic treatment of the present disclosure:

Statement 1. A device for orthodontic treatment, comprising: a first actuator configured to be attached to an orthodontic appliance and located proximate to a dentition; a second actuator configured to be attached to the orthodontic appliance and located proximate to the dentition; and a signal generator in electrical communication with the first actuator and the second [symbol] wherein the signal generator is configured to provide a first drive signal to the first actuator and a second drive signal to the second actuator to cause vibrational forces to be induced in the dentition and the induced vibrational forces interfere with one another to cause an increased amplitude at a predetermined location in the dentition.

Statement 2. The device of Statement 1, wherein the first actuator and the second actuator are piezoelectric actuators.

Statement 3. The device of Statement 2, wherein the first actuator and the second actuator comprise polyvinylidene fluoride.

Statement 4. The device of Statement 2, wherein the first and second actuators are formed within a common piezoelectric member.

Statement 5. The device of Statement 1, wherein the first and second actuators are electrically connected to the signal generator using rigid wires.

Statement 6. The device of any of Statement 1-5, further comprising a processor in electrical communication with the signal generator.

Statement 7. The device of Statement 6, further comprising a memory in electrical communication with the processor.

Statement 8. The device of Statement 7, wherein the memory contains computer-readable to cause the processor to record patient compliance and to monitor and report device status.

Statement 9. The device of Statement 8, further comprising a transceiver in communication with the processor.

Statement 10. The device of Statement 9, further comprising an energy storage device in electrical communication with the signal generator for providing power to the signal generator.

Statement 11. The device of Statement 10, further comprising a waterproof housing.

Statement 12. The device of Statement 1, wherein the signal generator comprises a first signal generator in electrical communication with the first actuator and a second signal generator in electrical communication with the second actuator.

Statement 13. A method of enhancing orthodontic treatment, comprising: imparting a first vibrational force on a dentition using a first actuator; imparting a second vibrational force on the dentition using a second actuator; and wherein the first and second vibrational forces are configured to interfere with one another to cause an increased amplitude at a predetermined location in the dentition.

Statement 14. A device for orthodontic treatment, comprising: a first piezoelectric actuator configured to be attached to an orthodontic appliance and proximate to a target tooth; a signal generator in electrical communication with the first piezoelectric actuator and configured to provide a drive signal to the first piezoelectric actuator to cause a vibrational force to be induced in the target tooth; and an energy storage device in electrical communication with the signal generator for providing power to the signal generator.

Statement 15. The device of Statement 14, further comprising a second piezoelectric actuator configured to be attached to the orthodontic appliance.

Statement 16. The device of Statement 15, wherein the first and second piezoelectric actuators are formed within a common piezoelectric material.

Statement 17. The device of Statement 15, further comprising a second signal generator in electrical communication with the second piezoelectric actuator and configured to provide a second drive signal to the second piezoelectric actuator.

Statement 18. The device of one of Statements 15-17, wherein the first and second piezoelectric actuators are configured to induce vibrational forces in the target tooth which interfere with one another to induce one or more localized areas of increased amplitude.

Statement 19. The device of Statement 1, further comprising a processor in electrical communication with the signal generator.

Statement 20. The device of Statement 19, further comprising a transceiver in communication with the processor.

Statement 21. A method of enhancing orthodontic treatment, comprising: imparting a first vibrational force on a target tooth using a first piezoelectric actuator; imparting a second vibrational force on the target tooth using a second piezoelectric actuator; and wherein the first and second vibrational forces are configured to interfere with one another, thereby creating one or more localized areas of increased amplitude.

Although the present disclosure has been described with respect to one or more particular embodiments and/or examples, it will be understood that other embodiments and/or examples of the present disclosure may be made without departing from the spirit and scope of the present disclosure. For example, various structural, logical, process step, and electronic changes may be made without departing from the scope of the disclosure. Hence, the present disclosure is deemed limited only by the appended claims and the reasonable interpretation thereof.

1. A device for orthodontic treatment, comprising:
a first actuator configured to be attached to an orthodontic appliance and located proximate to a dentition;
a second actuator configured to be attached to the orthodontic appliance and located proximate to the dentition; and
a signal generator in electrical communication with the first actuator and the second actuator, wherein the signal generator is configured to provide a first drive signal to the first actuator and a second drive signal to the second actuator to cause vibrational forces to be induced in the dentition and the induced vibrational forces interfere with one another to cause an increased amplitude at a predetermined location in the dentition.

2. The device of claim 1, wherein the first actuator and the second actuator are piezoelectric actuators.

3. The device of claim 2, wherein the first actuator and the second actuator comprise polyvinylidene fluoride.

4. The device of claim 2, wherein the first and second actuators are formed within a common piezoelectric member.

5. The device of claim 1, wherein the first and second actuators are electrically connected to the signal generator using rigid wires.

6. The device of claim 1, further comprising a processor in electrical communication with the signal generator.

7. The device of claim 6, further comprising a memory in electrical communication with the processor.

8. The device of claim 7, wherein the memory contains computer-readable to cause the processor to record patient compliance and to monitor and report device status.

9. The device of claim 8, further comprising a transceiver in communication with the processor.

10. The device of claim 9, further comprising an energy storage device in electrical communication with the signal generator for providing power to the signal generator.

11. The device of claim 10, further comprising a waterproof housing.

12. The device of claim 1, wherein the signal generator comprises a first signal generator in electrical communication with the first actuator and a second signal generator in electrical communication with the second actuator.

13. A method of enhancing orthodontic treatment, comprising:
imparting a first vibrational force on a dentition using a first actuator;
imparting a second vibrational force on the dentition using a second actuator; and
wherein the first and second vibrational forces are configured to interfere with one another to cause an increased amplitude at a predetermined location in the dentition.
